(19) United States
(12) Patent Application Publication
(10) Pub. No.: US 2016/0074911 A1
(43) Pub. Date: Mar. 17, 2016

(54) WASHING APPARATUS FOR REMOVING SUPPORT MATERIAL FROM 3D-PRINTED ARTICLES

(71) Applicant: QUILL INTERNATIONAL GROUP LIMITED, Melbourne, Derbyshire (GB)

(72) Inventor: David James DORE, Melbourne, Derbyshire (GB)

(73) Assignee: QUILL INTERNATIONAL GROUP LIMITED, Melbourn, Derbyshire (GB)

(21) Appl. No.: 14/783,017

(22) PCT Filed: Apr. 25, 2014
(86) PCT No.: PCT/GB2014/000153

§ 371 Date: Oct. 7, 2015

(30) Foreign Application Priority Data
Apr. 29, 2013 (GB) 1307693.0

(51) Int. Cl. B08B 3/02; B29C 67/00; B08B 3/10

(52) U.S. Cl. CPC B08B 3/02; B08B 3/10; B29C 67/0096; B33Y 40/00

(57) ABSTRACT

A 3D-printed article washing apparatus is provided for removing support material from such articles. The apparatus includes a washing unit and a soaking unit. The soaking unit has a chamber for holding an article to be soaked, a pump for circulating a soaking liquid through the chamber and a heater with a thermostatic control for heating the soaking liquid to a predetermined temperature for circulation through the chamber. The washing unit has a cabinet defining a washing compartment that has at least one liquid-discharging nozzle for spraying an article located therein with a washing liquid. Preferably, the cabinet is also provided with an air blower capable of supplying a jet of heated compressed air.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a washing apparatus for removing support material from articles made by additive manufacturing, commonly called 3D printing.

2. Description of Related Art Including Information Disclosed Under 37 CFR 1.97 and 37 CFR 1.98.

Articles made by additive manufacturing or 3D printing (hereinafter and in the claims referred to as ‘3D-printed articles’) are laid down in layers using a specialized computer-controlled printing machine. There are several different ways of producing articles by 3D printing. For example, in stereolithography (SLA) the printed material, which forms the article, or a support material is deposited on a platform over a cross-section of the article across X and Y axes. Once this has been completed, the printed layer may be cured by exposing it to ultra-violet light and then the platform is lowered, effectively lowering the article down the Z axis by a fraction of a millimeter (typically around 16 μm), and the process of drawing out and curing another layer on the X and Y axis is repeated. This process is performed over and over again until the entire article has been printed. The support material is laid down for any part of the article where there is an overhang or gap between moving parts and has to be removed once the printing is complete to reveal the finished article. In fused deposition modeling (FDM) the article is produced by extruding small beads of material that harden immediately to form layers. A thermoplastic filament or metal wire that is wound on a coil is unreeled to supply material to an extrusion nozzle head. The nozzle head heats the material and turns the flow on and off. Stepper motors or servo motors are employed to move the extrusion head and adjust the flow and the head can be moved in both horizontal and vertical directions. Thin supports have to be used in this method to support parts of some articles dependent on their shape.

Conventionally, removal of the support material is carried out by washing, dissolving and/or breaking or sucking away the support material, dependent on its type and the 3D printer is used. In those cases where the support material is washed or dissolved, the printed article usually is soaked in a solution of caustic soda at room temperature for several hours to soften and dissolve the support material and then the article is washed to remove any remaining traces. However, this method is inefficient and has been found not to remove all of the support material, especially in difficult to reach crevices of the article. Also, the support material removed from the article tends to settle out of the soaking solution and form a sludge at the bottom of the soaking vessel, which can be difficult to remove and dispose of safely.

If the article being printed is to be used commercially as opposed to being a pre-production model or prototype it is important that all of the support material is removed. This is particularly important if the article is a medical article for use in surgery, for example for implantation in the body. Many such articles also define narrow channels or capillaries that are filled during production with support material. Removal of support material from these channels is particularly challenging and often not possible with conventional removal techniques and equipment.

The object of the present invention is to provide a washing apparatus for removing support material from articles produced by 3D-printing that enables the support material to be removed more efficiently than using conventional methods and apparatus.

### BRIEF SUMMARY OF THE INVENTION

According to the present invention there is provided a 3D-printed article washing apparatus for removing support material from the article comprising a washing unit and a soaking unit, the soaking unit comprising a chamber for holding an article to be soaked, a pump for circulating a soaking liquid through the chamber and a heater with a thermostatic control for heating the soaking liquid to a predetermined temperature for circulation through the chamber; and the washing unit comprising a cabinet defining a washing compartment having at least one liquid-discharging nozzle for spraying an article located therein with a washing liquid.

Preferably, the cabinet of the washing unit is provided with an air blowing means. Advantageously, the air blowing means comprises an air-blowing nozzle that is adapted for connection to a supply of compressed air.

Preferably also, the soaking unit comprises an agitating means to agitate the soaking liquid in the basket.

Other preferred but non-essential features of the present invention are described in the dependent claims appended hereto.

### BRIEF DESCRIPTION OF THE DRAWINGS

The present invention will now be described by way of example with reference to the accompanying drawings, in which:

FIG. 1 is a perspective view of a washing apparatus according to the present invention, which is shown with a cupboard door open to reveal a soaking unit;

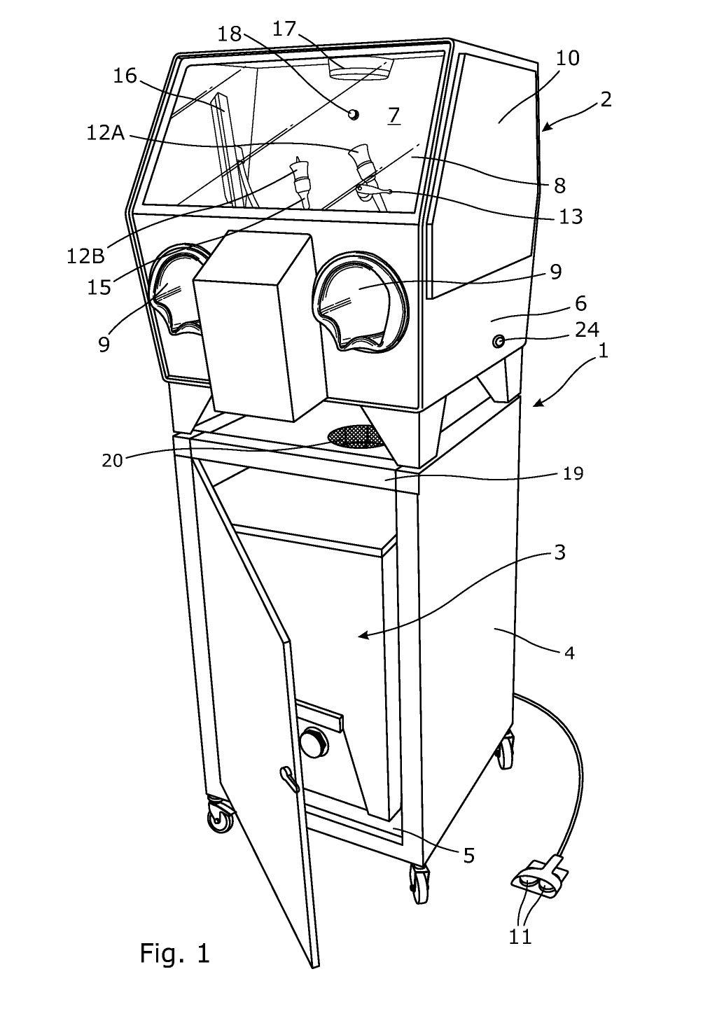

FIG. 2 is a diagram showing the interior of the rear of a cabinet of a washing unit of the apparatus;

FIG. 3 is a schematic perspective view of the soaking unit; and

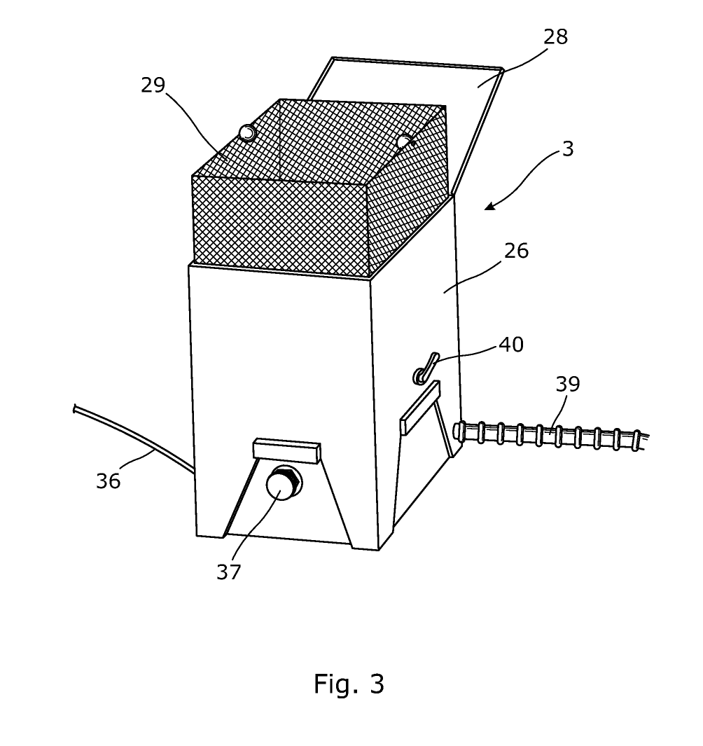

FIG. 4 is a diagram showing the interior set-up of the soaking unit shown in FIG. 3.

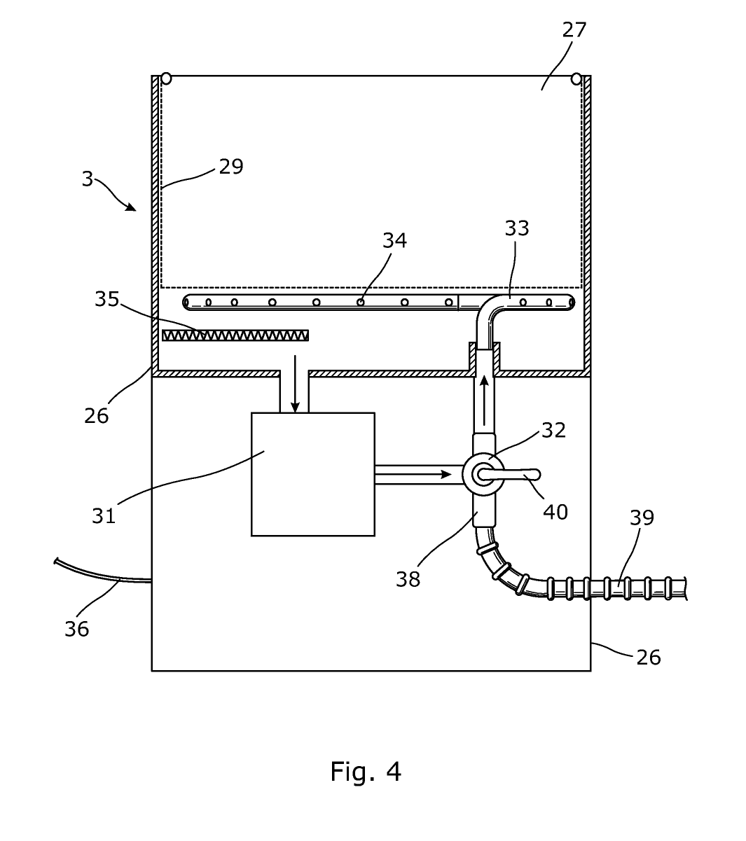

### DETAILED DESCRIPTION OF THE INVENTION

A washing apparatus 1 for washing 3D-printed articles, as shown in the drawings, comprises a washing unit 2 and a soaking unit 3, which is housed in a cupboard 4 on which the washing unit 2 sits. The soaking unit 3 sits on a sliding tray 5 within the cupboard 4 so that it can pulled out of the cupboard 4 to be loaded and unloaded with articles and then slid back into the cupboard 4 for operation or when not in use.

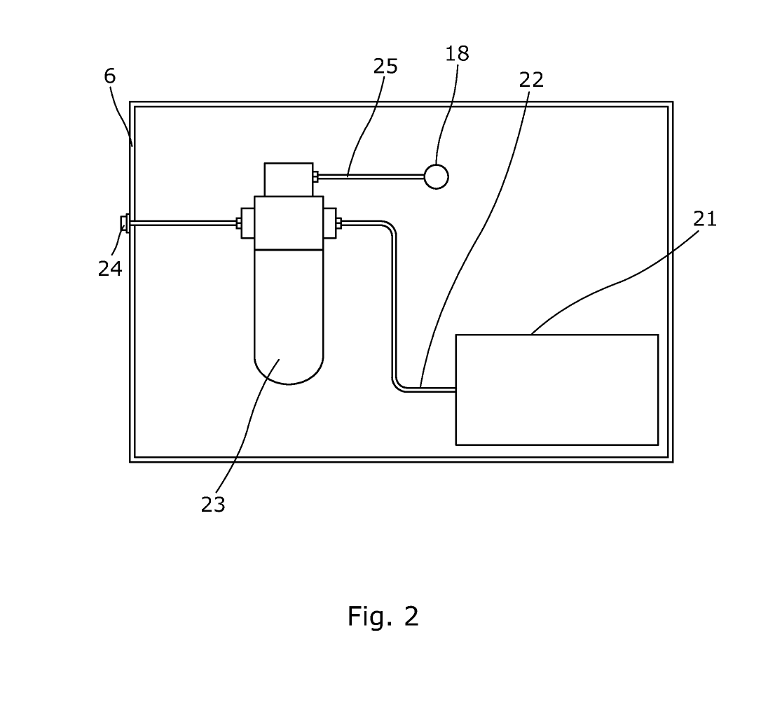

The washing unit 2 comprises a cabinet 6 defining an internal washing compartment 7. At the front of the cabinet 6 is a viewing window 8 above a pair of rubber gloves 9 that project into the compartment 7 to enable an operator to manipulate and manually wash an article within the compartment 7. At the side of the cabinet 6 is a door 10 through which an article can be introduced and removed from the compartment 7. The cabinet 6 is powered by a mains electricity supply via a first on/off switch mounted in a foot pedal 11 and is plumbed into a source of washing liquid, which may be a mains water supply. The washing liquid is selectively supplied to one of two liquid-discharging nozzles 12A and 12B within the compartment 7 by a lever switch 13, which is also located inside the compartment 7, via a pressure control valve (not shown). The nozzle 12A is attached to a flexible hose 14 and is adapted to provide a high pressure fan jet that can be used for removing large areas of support material from an article whereas the nozzle 12B, which is also attached to a flexible hose 15, is adapted to provide a pencil jet that can be used for cleansing delicate and/or complex areas of the article. The pressure control valve enables an operator to vary the pressure of washing liquid supplied to the nozzles 12A and 12B. The first on/off switch in the foot pedal 11 also controls operation of a wiper 16 that wipes the window 8 and a lamp 17 provided to illuminate the interior of the cabinet 6. In the centre at the rear of the compartment 7 is a fixed air-blowing nozzle 18 which is connected to a supply of compressed air, as is further described below with particular reference to FIG. 2. In other embodiments the nozzle 18 may be provided with a flexible hose so that it can be manipulated within the compartment 7 rather than being fixed to the rear wall.

At the bottom of the compartment 7 is a drain in the form of a tray 19 that is provided with a filter arrangement 20 to trap solid material from the washing liquid prior to it being evacuated from the machine 1. Preferably, the filter arrangement comprises a succession of finer and finer filters to filter out material from the washing liquid in different filter stages down to particulate material of 1 mm in size.

In embodiments where the washing unit 2 is not plumbed into a mains supply of water, the water or another washing liquid, for example a weak caustic soda solution, can be supplied from a source such as a drum (not shown) via a pump located in the cabinet 6 and evacuated via the drain to another drum for safe disposal.

In the cabinet 6 at the rear of the compartment 7 is located a source of compressed air for supplying the nozzle 18. In the illustrated embodiment this comprises a compressor 21, which is powered the mains electricity supply via a second an on/off switch mounted in the foot pedal 11. The compressed air output of the compressor 21 is fed through a pipe 22 to a heating means 23 that is thermostatically controlled by a manual dial 24 on the side of the cabinet 6. The heated compressed air is then fed to the nozzle 18 via a pipe 25. The manually adjustable thermostat thereby enables the output temperature of the air provided by the nozzle 18 to be controlled. In other embodiments, the compressor 21 may be replaced by a replaceable canister of compressed air or, where appropriate, the apparatus may be plumbed into a supply of compressed air. In both of the latter cases, the on/off switch in the foot pedal 11 can be adapted to open or close a valve supplying the compressed air to the heating means.

The heating means 23 can be of any conventional type. It may comprise a simple electrical element located within an appropriate section of the pipe 22 or it may comprise an electrical element located around the exterior of part of the pipe 22. In other embodiments, an appropriate section of the pipe 22 may be located within a heated bath so that the air within the pipes 22 is also heated. Such a bath may be supplied with heated liquid by the soaking unit 3, which will now be described.

The soaking unit 3 comprises a housing 26 in the upper part of which is located a water-tight upper chamber 27 covered by a lid 28. A removable, preferably perforated, basket 29 is located in the chamber 27 for holding one or more 3D-printed articles to be soaked. In use, the chamber 27 is filled with sufficient soaking liquid to cover the articles in the basket 29 by an operator. The soaking unit 3 is adapted to circulate the soaking liquid so that the liquid in contact with the articles is in constant motion. To this end, beneath the basket 29 but within the chamber 28 is a drain 30 connected to a pump 31. The pump 31 draws the soaking liquid from the chamber 27 and then pumps it via a valve 32 back into the chamber 27 through a pipe 33 that is located in the chamber 27 beneath the basket 29. The pipe 33 is formed into an annular shape and defines one or a series of spaced holes 34 through which one or more jets of soaking liquid can issue from the pipe 33, thereby forming a spraying means that agitates the soaking liquid in the chamber 27 and the basket 29. The basket 29 may also include a mesh panel or similar that can be fitted partway up the basket 29 to retain lightweight articles that may otherwise float below the level of the liquid in the chamber 27.

Also located in the chamber 21 beneath the basket 23 is an immersion heater 35 with a thermostatic control which can set to heat the soaking liquid to predetermined temperature by an operator. The heater 35 and the pump 31 are electrically powered by a mains supply via a power cable 36, which may be also be used for powering the washing unit 2. An on/off switch 37 for the mains supply is located on the front of the housing 26.

The valve 32 is preferably a three-way valve, receiving the soaking liquid from the pump 31 and directing it either to the pipe 33 or into a drain 38 attached to a flexible hose 39 which can be used to drain the soaking liquid out of the chamber 27 for safe disposal. The valve 32 is manually operated by a lever 40 located on the exterior of the housing 26 so that the soaking liquid is either circulated through the chamber 27 or is pumped into the drain hose 39.

In some embodiments, as described above, the heated soaking liquid can be used to heat the compressed air supplied by the nozzle 18. In this case the hose 39 may direct at least a quantity of the waste soaking liquid to the heating means 23 that in this case will take the form of a bath through which the pipe 22 is led. The bath may include a top-up, thermostatically controlled immersion heater (not shown) to enable the bath to reach an appropriate temperature to heat the compressed air adequately. After use, the liquid in the bath can then be drained back into the hose 39 for safe disposal.

The washing apparatus can be used to provide a variety of methods of washing the 3D-printed article dependent on the type of 3D printer used for its production. An example of such a method will now be described. This method is suitable

A 3D-printed article is firstly located within the washing compartment 7 through the door 10, which is then closed. After switching the washing unit 2 on via the appropriate switch on the foot pedal 11 and using the rubber gloves 9, the operator can manipulate the article and spray it with washing liquid using the nozzles 12A and 12B to remove loose support material from the article. Preferably, the article is sprayed with the washing liquid, which may be water or other suitable liquid such as a caustic soda solution, for an appropriate time period, typically approximately 10 minutes. After removal of loose support material, which is washed away with the washing liquid and can be recovered for safe disposal via the filter arrangement, the article is transferred to the soaking unit 3, which can be pulled out of the cupboard 4 on the tray 5 for this purpose.

Prior to use, the chamber 21 of the soaking unit 3 should be filled with sufficient soaking liquid to cover any articles to be soaked that are located in the basket 29. Preferably, the soaking liquid comprises an aqueous solution of caustic soda, for example a 5% by weight aqueous solution of caustic soda. The soaking liquid can be used for several separate soaking operations and the basket 29 filled with several articles that can be soaked in the same soaking operation.

Once the basket 29 has been filled with as many articles to be soaked as required, the soaking unit 3 can be switched on. This commences operation of the pump 31 and the immersion heater 35, which will heat the soaking solution to a predetermined temperature as set by the operator beforehand via the thermostatic control. This temperature is above ambient but lower than a temperature at which the material from which the article has been printed deforms. Preferably, the soaking liquid is heated to a temperature in a range of between ambient and 90° C. For articles printed by SLA printers, the soaking liquid may be heated to a temperature between 30° C. and 45° C. inclusive dependent on the type of support material to be dissolved away. However, for articles printed by FDM printers, the soaking liquid may be heated to higher temperatures, for example between 65° C. and 70° C. or more. The pump 31 circulates the soaking liquid through the basket over the articles therein and this speeds up removal of the support material therefrom. Preferably, the soaking liquid is circulated at an approximate rate of 20 litres per minute by the pump 31.

As described above, the soaking liquid is also agitated by the jets issuing from the holes 34 in the pipe 33, which also assists in removal of the support material from the article or articles in the basket 29. In total, the article or articles are preferably soaked in the circulating, agitated soaking liquid for at least approximately 30 minutes. After this time period, the soaking unit 3 may be switched off, the basket 29 lifted out of the soaking unit 3 and the article recovered and transferred back into the washing compartment 7. The soaking solution may be left in the chamber 27 for reuse, partially or fully drained for use within the heating means 23 or drained away for disposal as appropriate. The basket 29 can then be replaced in the soaking unit 3 which can then be slid back into the cupboard 4.

Once back in in the washing compartment 7, the article is again spraying with washing liquid using the nozzles 12A, 12B to remove remaining any support material and to rinse away the soaking liquid. Preferably, the article is sprayed using a high pressure jet of washing liquid for at least approximately 10 seconds. After washing with the washing liquid, the article may also be treated with a jet of heated compressed air via the nozzle 18. The supply of compressed can be switched on via the foot pedal and the article manipulated in front of the nozzle 18 so that appropriate parts of it are plied with the air jet. As the air jet is heated to an appropriate temperature, which is controlled by the dial 24, any remaining support material is prevented from resolidifying and, having been loosened by the soaking and washing operations, can be blown off the article. The heated air jet is particularly suitable for ensuring support material is removed from small channel and capillaries formed in the article as it can penetrate such areas. Preferably, the compressed air is supplied to the nozzle 18 at around 11 litres per minute and is heated to between 60° C. and 65° C. inclusive. The article should now be dry, free of all support material and ready for use.

As indicated above, the manner of using the washing apparatus according to the invention can be varied dependent on the article and the 3D printing process used for its production. This includes varying the temperatures of the soaking and washing liquids, varying the time spent in the washing and soaking unit 2, 3 and varying the order in which the article is treated with the various processes that the apparatus us capable of. For example, the initial washing process can be omitted or order in which the soaked article is blasted with air or washing liquid can be varied. In some cases it may not be necessary to air blast the article. Equally, other articles maybe soaked, washed, re-soaked, washed and then blasted with air to for final cleaning and drying.

Overall, it has been found that the method and apparatus enables the removal of support material from a 3D-printed article more efficiently than conventional methods. For example, using two identical 3D-printed articles weighing 86.90 g prior to washing, the method according to the invention was compared with a conventional simple soaking method to remove the support material from the articles. The article simply soaked overnight in a solution of caustic soda and then washed off in accordance with conventional washing methods weighed 70.61 g whereas the article subjected to the method according to the present invention using a soaking time of 30 minutes weighed 51.96 g demonstrating that considerably more support material has been removed from it.

The apparatus according to the present invention also enables spent soaking liquid, which is typically environmentally unfriendly, to be easily disposed of safely and ensures that pieces of support material recovered from the filter arrangement are not simply washed into the mains sewerage system.

1. A 3D-printed article washing apparatus for removing support material from the article comprising a washing unit and a soaking unit, the soaking unit comprising a chamber for holding an article to be soaked, a pump for circulating a soaking liquid through the chamber and a heater with a thermostatic control for heating the soaking liquid to a predetermined temperature for circulation through the chamber; and the washing unit comprising a cabinet defining a washing compartment having at least one liquid-discharging nozzle for spraying an article located therein with a washing liquid.

2. An apparatus as claimed in claim 1, wherein the cabinet of the washing unit is provided with an air blowing means.

3. An apparatus as claimed in claim 2, the air blowing means comprises an air-blowing nozzle that is adapted for connection to a supply of compressed air.

4. An apparatus as claimed in claim 2, wherein a heating means is provided for heating the air supplied to the air blowing means.

5. An apparatus as claimed in claim 4, wherein the heating means is provided with a manually adjustable thermostat whereby the output temperature of the air provided by the air blowing means is controlled.

6. An apparatus as claimed in claim 1, wherein the soaking unit comprises an agitating means to agitate the soaking liquid in the chamber.

7. A washing machine as claimed in claim 6, wherein the agitating means comprises one or a plurality of jets of the soaking liquid that are directed into the chamber.

8. A washing machine as claimed in claim 7, wherein the agitating means comprises a pipe through which the soaking liquid is pumped into the chamber, the pipe defining a series of spaced holes through which jets of soaking liquid issue from the pipe into the chamber.

9. A washing machine as claimed in claim 1, wherein a three-way valve is provided that receives soaking liquid from the pump and directs it either to the agitating means or into a drain.

10. A washing machine as claimed in claim 9, wherein the valve is connected to a drain hose and is manually operable to direct the soaking liquid to the agitating means or into the drain hose.

11. A washing machine as claimed in claim 10, wherein a heating means is provided for heating the air supplied to the air blowing means and wherein at least a proportion of the soaking liquid is used within the heating means to heat the air supplied to the air blowing means.

12. A washing machine as claimed in claim 1, wherein a perforated, removable basket is located in the chamber to contain the article to be soaked.

13. A washing machine as claimed in claim 1, wherein said at least one liquid-discharging nozzle in the washing compartment is connected to a source of washing liquid via a manually adjustable pressure control valve enabling said nozzle to operate with a range of liquid pressures.

14. A washing machine as claimed in claim 1, wherein a second liquid-discharging nozzle is provided in the washing compartment and is adapted to produce a pencil jet of washing liquid for cleansing delicate and/or complex areas of the article.

15. A washing machine as claimed in claim 14, wherein the second liquid-discharging nozzle is connected to the same source of washing liquid as the first nozzle, a selector switch being provided to enable the source of washing liquid to be switched from one nozzle to the other.

16. A washing machine as claimed in claim 1, wherein the washing compartment has a drain provided with a filter arrangement to trap solid material from the washing liquid.
